(19) United States
(12) Patent Application Publication
(10) Pub. No.: US 2008/0036160 A1
(43) Pub. Date: Feb. 14, 2008

(54) Flat Seal

(76) Inventor: Ralf Flemming, Langenbach (DE)

Correspondence Address: Robert L. Stearns;Dickinson Wright PLLC, 38525 Woodward Avenue, Suite 2000, Bloomfield Hills, MI, 48304-5092, US

(21) Appl. No.: 11/571,491

(22) PCT Filed: May 24, 2005
(86) PCT No.: PCT/DE05/00939

§ 371 Date: Dec. 29, 2006

(30) Foreign Application Priority Data
Jun. 30, 2004 (DE) 10 2004 031 611.2

(51) Int. Cl. F02F 1/24; F16J 15/08

(52) U.S. Cl. 277/595

(57) ABSTRACT

Flat seal, comprising at least one metallic layer, which is supplied with several passages, spaced by bridges, whereby at least one corrugation and/or at least one profile is to be set out at least for the area of one of the layers, on the passage side and at least for part of the area; whereby the corrugation surrounds the passages in a spectacles shape and the profile, which generally fully surrounds the pertaining passages, is set out within the corrugation.

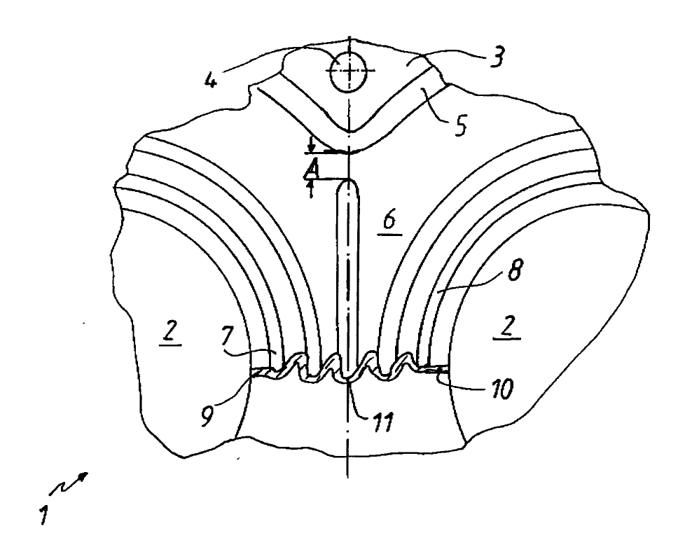

The invention concerns a flat seal, comprising at least one metallic layer, which is to be supplied with several passages, spaced by bridges, whereby at least one corrugation and/or at least one wavelike contouring is to be set out at least in the area of one of the layers, on the passage side and at least for part of the area.

A flat seal and its manufacturing procedure is described in the WO 01/96768. The flat seal is furnished with at least one passage, whereby this passage or at least one of the metallic layers is developed in the form of a wave and/or tooth-shaped contouring surrounding the passage(s) at least in part. Corrugation areas are provided along with the profiles on the bridge side.

The invention is based on the task of developing a generic flat seal to that effect that sufficient compression can still be ensured in the bridge area even if corrugation is omitted.

This task is solved in accordance with the invention by the features of claim 1.

Further advantageous embodiments of the invention are apparent from the sub-claims.

Sufficient compression of the flat seal can be ensured, as the corrugation no longer reaches the bridge and the wavelike profile is provided in place of said corrugation. This also in view of the fact, that the installation area previously used for the corrugation can now be filled with an accordingly increased number of shafts. Because the corrugation shows a defined distance to the contouring and especially the straight course of the wave crest, it is ensured in this unattached area, that the straight area of the contouring generates sufficient sealing pressure.

Depending on the type of embodiment of the flat seal similar or dissimilar wave sections may be employed with differing widths and/or heights, if required.

The flat seal in accordance with the invention is usable as a cylinder head gasket for a combustion engine as per another aspect of the invention.

The object of invention is illustrated with an embodiment example in the drawing and is described as follows.

The only illustration shows in the top view a detail of a flat seal usable as cylinder head gasket 1. The passages 2 are visible. The cylinder head gasket 1 shall in this example consist only of layer 3. The object of invention is not limited to single layer flat seals, in particular cylinder head gaskets, though; rather, additional layers maybe be provided for.

Corrugation 5, in this example designed as a full corrugation, is shaped in the form of spectacles and surrounds the passages 2 as well as the screw holes 4, without coming into the pertaining bridge 6. A wavelike contouring 7, 8, surrounding passage 2, is provided within the geometrical form of corrugation 5. In the area of passage 2, the pertaining contouring 7, 8 extends into flat webs 9, 10.

Between the adjacent passages 2, which serve as openings for the combustion chamber of the combustion engines, there is a small area, also described as bridge 6. In the area of the bridges 6 wave crest 11 of contouring 7, 8 runs straight. The straight wave crest 11 is not designed surrounding passages 2 but ends in the entry and exit area of the bridges 6.

A defined distance A to corrugation 5 is created thus.

1-6. (canceled)

7. A flat seal assembly comprising:
at least one metallic layer having at least a pair of passages and a bridge section separating said passages;
a continuous corrugation surrounding said passages and spaced from said bridge section;
at east one additional corrugation fully surround each of said passages inwardly of said continuous corrugation; and
at least one further corrugation in said bridge section extending straight and termination short of said continuous corrugation by a predetermined distance.

8. The assembly of claim 7 wherein said at least one additional corrugation comprises a waveform profile and said at least one metallic layer includes a flat web surrounding each of said passages inwardly of said at least one additional corrugation.

9. The assembly of claim 7 wherein said flat seal comprises a cylinder head gasket.
